(19) United States
(12) Patent Application Publication
(10) Pub. No.: US 2010/0171743 A1
(43) Pub. Date: Jul. 8, 2010

(54) SOUND PICKUP APPARATUS

(75) Inventor: Toshiyuki Hata, Hamamatsu-shi (JP)

Correspondence Address: ROSSI, KIMMS & McDOWELL LLP., 20609 Gordon Park Square, Suite 150, Ashburn, VA, 20147, US

(73) Assignee: YAMAHA CORPORATION, Hamamatsu-shi, Shizuoka (JP)

(21) Appl. No.: 12/676,535

(22) PCT Filed: Sep. 3, 2008
(86) PCT No.: PCT/JP2008/065908

§ 371 Date: Mar. 4, 2010

(30) Foreign Application Priority Data
Sep. 4, 2007 (JP) 2007-228683

(51) Int. Cl. G06T 11/20; H04R 9/08

(52) U.S. Cl. 345/440; 381/356

(57) ABSTRACT

A sound pickup apparatus capable of submitting an optimum sound pickup environment to the user in a more easily understandable manner is implemented. A sound output-pickup function apparatus 1 is placed at a predetermined position and connected to a PC 2 by a USB cable 300. When a user 900 operates a sound output-pickup function apparatus 1, to thus launch a sound output-pickup application, the sound output-pickup function apparatus 1 detects a turn amount of each of sub-housings 11, 12 and delivers the detected turn amounts to the PC 2. The PC 2 calculates a positional relationship between the main housing 10 and the sub-housings 11 and 12 from the acquired turn amounts, thereby determining a usage mode exhibiting the same positional relationship. When determined that an equivalent usage mode is available, the PC 2 displays an indicator display including the shape of the sound output-pickup function apparatus 1, the number of persons, person's positions, and a sound pickup range, all conforming to the equivalent usage mode. The user 900 ascertains an optimum number of persons and optimum person's positions by taking a look at the indicator display.

### TECHNICAL FIELD

The present invention relates to a sound pickup apparatus that implements a plurality of usage modes commensurate with the number of persons and seat positions of the persons.

### BACKGROUND ART

In such a case where a conference is held between remote locations by way of a communication network, a sound pickup apparatus is installed in each of conference rooms. In order to check whether or not remarks of conferees are surely picked up on this occasion, a method for indicating signal levels of sound pickup signals collected from a plurality of directions has already been available as described in; for instance, Patent Document 1.

Patent Document 1: JP-A-6-233366

### DISCLOSURE OF THE INVENTION

### Problem that the Invention is to Solve

However, under the method of Patent Document 1, a turnable section of the sound pickup apparatus is turned, and a change in signal level acquired during the course of turning action is checked, whereby a sound pickup direction is determined. Therefore, a reference by which to determine a turn stop position; namely, a sound pickup direction, is only a sound pickup level. When information for stopping turning action is scanty as mentioned above, it becomes difficult for the users to adjust an optimum sound pickup direction.

The present invention therefore aims at realizing a sound pickup apparatus that can provide the users with an optimum sound pickup environment more plainly.

### Means for Solving the Problem

A sound pickup apparatus of the present invention includes a main housing having a sound pickup section, and a plurality of sub-housings each of which has a sound pickup section and is provided so as to be turnable with respect to the main housing. Further, the sound pickup apparatus includes a turn amount detection section that detects amounts of turns of the plurality of sub-housings with respect to the main housing, a usage mode determination section that detects an actually measured positional relationship between the main housing and the plurality of sub-housings based on the amounts of the turns and determines an optimum usage mode appropriate for the actually measured positional relationship, a display control section that generates display data including the actually measured positional relationship and the optimum usage mode, and a display section that displays the display data.

In the configuration, the sound pickup sections provided in the main housing and the plurality of sub-housings pickup sound. In a case that the plurality of sub-housings perform a turn with respect to the main housing, whereby a plurality of different sound pickup ranges can be set according to a turned state; namely, a positional relationship between the main housing and the sub-housings. An appropriate usage mode can be set for each of the sound pickup ranges according to a sound pickup characteristic of the sound pickup sections. The usage mode corresponds to information set according to the sound pickup range; namely, the number of persons who take seats around the sound pickup apparatus, positions of the persons, and the like. Through use of the concept, the sound pickup apparatus of the present invention acquires current turn amounts; namely, an actually measured positional relationship between the main housing and the sub-housings; sets a usage mode optimum for the detected actually measured positional relationship; and displays the actually measured positional relationship and the usage mode. A usage mode (the number of persons, positions where the persons take seats, and the like) optimum for the current set state of the apparatus can be submitted to the user.

The usage mode determination section of the sound pickup apparatus of the present invention stores a plurality of usage modes and preset positional relationships between the main housing and the plurality of sub-housings corresponding to the plurality of usage modes while associating the usage modes with the positional relationships respectively. The usage mode determination section determines a usage mode corresponding to the actually measured positional relationship as the optimum usage mode when the actually measured positional relationship is equal to any one of the preset positional relationships corresponding to the stored usage modes, and determines that an appropriate usage mode is not available when the actually measured positional relationship is not equal to any one of the preset positional relationships corresponding to the stored usage modes. The display control section generates the display data including absence of the appropriate usage mode and the actually measured positional relationship when the appropriate usage mode is not available.

In this configuration, a plurality of usage modes and a plurality of preset positional relationships are stored while being associated with each other. A usage mode associated with a preset positional relationship closest to the actually measured positional relationship is selected as an optimum usage mode. The usage mode determination sections determines, on this occasion, whether or not the actually measured positional relationship is equivalent to the preset positional relationship, according to predetermined conditions. A determination is made under conditions; for instance, whether or not turn angles of the actually measured positional relationship fall within a range of ±10 degrees with reference to a turn angle determined by the preset positional relationship, or the like. The usage mode determination section displays that an optimum usage mode cannot be submitted in connection with the current positional relationship between the main housing and the sub-housings when the actually measured positional relationship cannot be deemed to be equivalent to any of preset positional relationships of all usage modes. Specifically, under a usage method falling within a previously-assumed range, there is a potential risk of a failure to appropriately pickup sound. The user can thereby perform additional turning of the sub-housings, or the like, while recognizing the potential risk of a failure to appropriately pickup sound in the current installed state of the apparatus.

The usage mode determination section of the sound pickup apparatus of the present invention determines a usage mode of an analogous preset positional relationship as the optimum usage mode when the actually measured positional relationship is analogous to any one of the preset positional relationships corresponding to the stored usage modes. The display control section generates the display data including the analogous preset positional relationship and the actually measured positional relationship when the usage mode corresponding to the analogous preset positional relationship is available.

In the configuration, when the actually measured positional relationship is not equivalent to any of the preset positional relationships as mentioned above, an analogous preset positional relationship is detected. According to predetermined conditions, the usage mode determination section determines, on this occasion, whether or not the actually measured positional relationship is analogous to the preset positional relationship, as in the case where the actually measured positional relationship is equal to the preset positional relationship. A determination is made under conditions; for instance, whether or not turn angles of the actually measured positional relationship fall within a range of ±30 degrees with reference to a turn angle determined by the preset positional relationship, or the like. When an analogous preset positional relationship is acquired, there are displayed an analogous usage mode and a preset positional relationship of the analogous usage mode along with the actually measured positional relationship. The user can thereby recognize the usage mode similar to the actually measured current positional relationship and the positional relationship between the main housing and the sub-housings of the usage mode. While viewing the display, the user can readily perform additional turning of the sub-housings so as to achieve a preset positional relationship of a selected, analogous usage mode.

The turn amount detection section of the sound pickup apparatus of the present invention detects a change in the amounts of the turns. The usage mode determination section detects a change in the actually measured positional relationship corresponding to the change in the amounts of the turns. The display control section generates the display data in accordance with the change in the actually measured positional relationship.

In the configuration, the turn amounts are detected and displayed at all times even in the middle of turning action. When the sub-housings are turned to preset positions as mentioned previously, the user can readily ascertain whether or not the sub-housings approach the preset positions or have already been turned to positions equal to the preset positions, while viewing the display.

The turn amount detection section of the sound pickup apparatus of the present invention is a rotary encoder.

In the configuration, a general purpose rotary encoder is used as the turn amount detection section. A sound pickup apparatus that has a mechanism which is easy to acquire and which can accurately detect a turn amounts and that yields the foregoing working effects can readily be realized.

The sound pickup apparatus of the present invention additionally has the sound output section provided in the main housing. The turn amount detection section detects the amounts of the turns based on a relationship of delay in picked-up audio signals acquired by picking up a sound output from the sound output section at the sound pickup sections of the main housing and the plurality of sub-housings.

In this configuration, the sound pickup apparatus has the sound output section and the sound pickup section, and there is utilized a fact that a sound pickup pattern obtained as a result of the respective sound pickup section acquiring sound output from the sound output section depends on the positional relationship (the turn amounts) between the main housing and the sub-housings. Sound pickup patterns corresponding to respective turn amounts are acquired before hand, and an actually measured sound pickup pattern is compared with the previously-acquired sound pickup patterns, thereby detecting turn amounts. As a result, turn amounts can be detected without use of mechanical components, such a rotary encoders, and substantial addition of a configuration to the sound output pickup function and by use of the sound output section and the sound pickup section provided in the sound pickup apparatus, memory for storing sound pickup patterns, and a computing element that analyzes the sound pickup patterns.

The sound pickup apparatus of the present invention further includes a turning section that turns the sub-housings with respect to the main housing, and a turning operation input section that accepts an operation input regarding the turn of the turning section. The main housing, the sub-housings, the turn amount detection section, and the turning section are provided in a main device that is stationarily set at a predetermined position. The display section and the turning operation input section are provided in an operation device.

In this configuration, the turn operation input section and the display section are provided in a PC or a remote controller placed at user's hand, or the like, whereby turning action is remotely operated. As a result, for instance, the user can perform operation for turning the sub-housings while seated and check an optimum usage mode. The user can also ascertain seat positions of respective persons while viewing the selected usage mode at hand.

### ADVANTAGE OF THE INVENTION

The present invention provides the users with an optimum usage mode (the number of persons, seat positions for the persons, and the like) optimum for a current installed state of a sound pickup apparatus. Respective persons can easily, accurately take seats at optimum positions by taking a glance at a displayed pattern. Remarks of respective persons are picked up by the sound pickup apparatus more reliably.

### BRIEF DESCRIPTION OF THE DRAWINGS

FIG. 1 It is a plan view of a sound output pickup function apparatus 1 of an embodiment of the present invention achieved in a reference position.

FIG. 2 It is a functional block diagram of the sound pickup apparatus of the embodiment made up of a sound output-pickup function apparatus 1 and a PC 2 of an exemplary embodiment.

FIG. 3 It is a flowchart showing execution flow of sound output-pickup application.

FIG. 4(A) is a view showing a setting status of a first embodiment, FIG. 4(B) is a diagram showing an indicator display screen of a PC achieved in the setting status shown in FIG. 4(A), and FIG. 4(C) is a view showing a system setting display screen.

FIG. 5 It is a view showing a state in which users actually took seats after performance of the settings shown in FIGS. 4(A), 4(B), and 4(C).

FIG. 6(A) is a view showing a setting status of a second embodiment, and FIG. 6(B) is a view showing an indicator display screen of a PC achieved in the setting status shown in FIG. 6(A).

FIG. 7 (A) is a view showing turning operation of sub-housings, and FIG. 7(B) is a view showing a change in indicator display achieved when turning operation shown in FIG. 7(A) is performed.

FIG. 8 It is a view showing a status in which the users actually took seats after performance of the settings shown in FIGS. 6(A) and 6(B).

FIGS. 9(A) and 9(B) show indicator displays achieved in other usage modes, and FIG. 9(C) shows an indicator display achieved when no optimum usage mode is available.

### DESCRIPTIONS OF THE REFERENCE NUMERALS AND SYMBOLS

1—SOUND OUTPUT-PICKUP FUNCTION APPARATUS
10—MAIN HOUSING
11, 12—SUB-HOUSING
110—CONTROL SECTION
111—INPUT-OUTPUT I/F
112—SOUND OUTPUT CONTROL SECTION
113—SOUND INPUT CONTROL SECTION
114—ECHO CANCELLER
115—OPERATION SECTION
1160, 1161, 1162—MICROPHONE ARRAY
1171, 1172—ROTARY ENCODER
MIC—MICROPHONE
SP—SPEAKER
2—PC
210—CPU
211—APPARATUS I/F
212—COMMUNICATION I/F
213—STORAGE MEDIUM
214—RAM
215—OPERATION SECTION
216—DISPLAY SECTION
300—USB CABLE
400—NETWORK
900—902 USER

### BEST MODE FOR IMPLEMENTING THE INVENTION

A sound pickup apparatus of the present invention is described by reference to the drawings. The sound pickup apparatus has a sound output-pickup function apparatus 1 that chiefly outputs and picks up sound and detects amount of turn and a PC 2 that chiefly performs usage mode selection, a usage mode display, and the like.

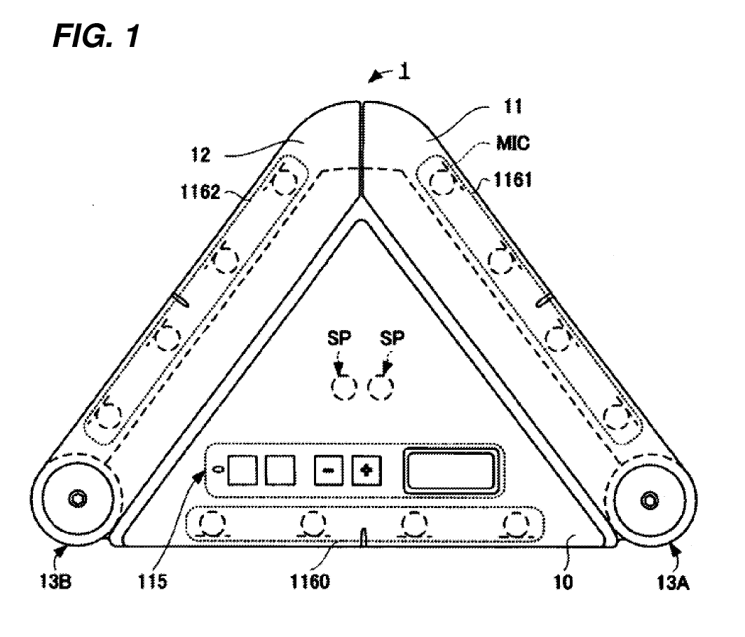

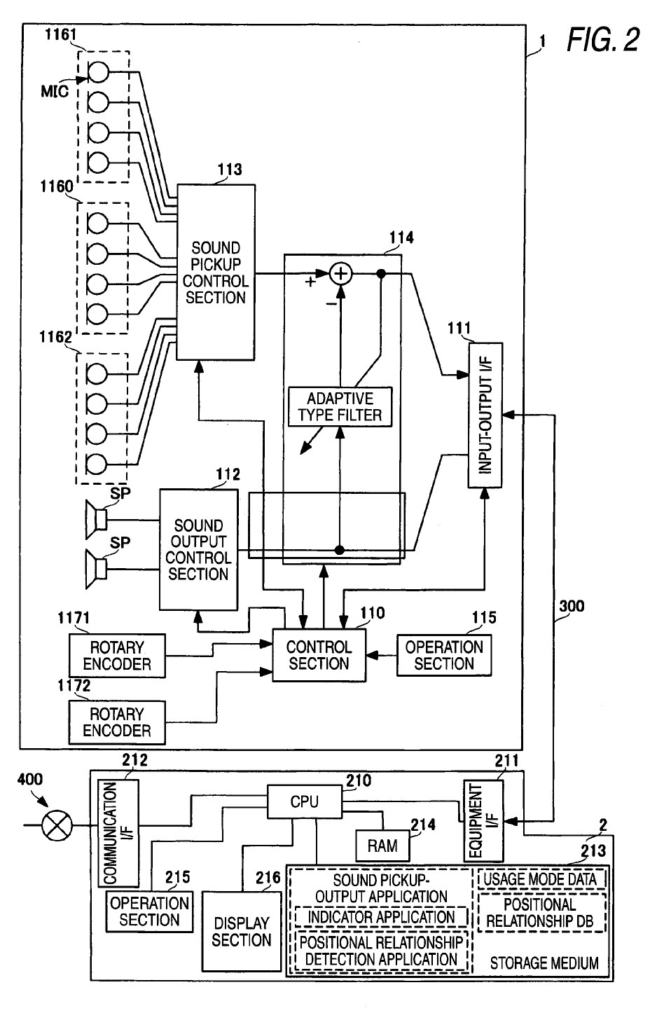

FIG. 1 is a plan view of a sound output pickup apparatus 1 of an embodiment of the present invention achieved in a reference position. FIG. 2 is a functional block diagram of the sound pickup apparatus of the embodiment made up of a sound output-pickup function apparatus 1 and a PC 2.

The sound output-pickup function apparatus 1 is made up of a main housing 1 and two sub-housings 11 and 12 that are disposed so as to be mechanically turnable with respect to the main housing 1. In the following descriptions, four microphones MIC are set on each of the main housing 1 and the sub-housings 11 and 12. Two speakers SP are set on the main housing 1. The number of microphones MIC and the number of speakers SP can appropriately be set according to specifications.

The main housing 10 assumes a substantially-triangular shape when viewed from top and has such a thickness that microphones MIC can be set along a sidewall of the main housing. The main housing 10 has three sidewalls, and four microphones MIC are set in an interior of a front sidewall (a sidewall having a wall surface oriented in a downward direction in FIG. 1) so as to pick up sound in a direction from the front sidewall toward the outside. The four microphones MIC are arranged at predetermined intervals parallel to the front sidewall, whereby a microphone array 1160 having a sound pickup area oriented from the front sidewall to the outside is built from the four microphones.

An operation section 115 made up of a plurality of operation members is set on an upper surface of the main housing 10 (the surface viewed from top in FIG. 1). The plurality of operation members are arranged; for instance, parallel to the front sidewall as shown in FIG. 1. The plurality of operation members include; for instance, an operation member for accepting a start or end of a sound output-pickup application to be described later, an operation member for accepting a preset assignment, an operation member for accepting volume control of output sound, an operation member for accepting microphone mute, and the like.

Two speakers SP are set in an interior of the neighborhood of a substantial center of a triangle achieved when the main housing 10 is viewed from top. The speakers are aligned parallel to the front sidewall and spaced apart from each other such that dipole speaker control is feasible.

An area of an upper surface of the main housing 10 except the operation section 115 and the front sidewall are machined into a mesh.

Although unillustrated, a USB connection terminal, an analogue audio input terminal, an analogue audio output terminal, and a power input terminal are disposed as an input-output I/F 111 (FIG. 2) at a corner diagonal to the front sidewall of the main housing 10.

Corners at both ends of the front sidewall of the main housing 10 correspond to a pivotal joint section 13A of the sub-housing 11 and a pivotal joint section 13B of the sub-housing 12, respectively. The sub-housings 11 and 12 turn around the pivotal joint sections 13A and 13B with respect to the main housing 10. Rotary encoders 1171 and 1172 (FIG. 2) are provided at the respective pivotal joint sections 13A and 13B. The rotary encoder 1171 acquires a detection signal commensurate with an amount of turn of the sub-housing 11, and the rotary encoder 1172 acquires a detection signal commensurate with an amount of turn of the sub-housing 12.

Each of the sub-housings 11 and 12 is made up of a substantially-parallelepiped shape. A length of a long side of the parallelepiped shape is substantially identical with one side of the triangle of the main housing 10, and a length of a short side of the parallelepiped shape is predetermined. Further, the thickness of the parallelepiped shape is the same as that of the main housing 10. The respective sub-housings 11 and 12 are connected, at single ends of their long sides, to the main housing 10 by the pivotal joint sections 13A and 13B. The sub-housings 11 and 12 make a turn within a range by way of a position where the direction of the long side becomes parallel to the front sidewall of the main housing 10. At one end of the range, the entire long sides of the respective sub-housings 11 and 12 remain in contact with the main housing 10. At the other end of the range, the long sides of the sub-housings project further toward the front at a predetermined angle with respect to the front sidewall of the main housing 10.

Four microphones MIC are set on the sub-housing 11 so as to pick up sound in an outward direction opposite to the direction of the main housing 10 (i.e., in an upper right direction in FIG. 1) while the sub-housing remains in contact with one sidewall of the main housing 10 (an upper right sidewall in FIG. 1). These microphones MIC are spaced apart from each other at predetermined intervals along the direction of the long side of the sub-housing 11. A microphone array 1161 that picks up sound in an area outside the side surface of the sub-housing 11 along which the microphones MIC are set is built from the four microphones MIC.

Four microphones MIC are set on the sub-housing 12 so as to pick up sound in an outward direction opposite to the direction of the main housing 10 (i.e., in an upper left direction in FIG. 1) while the sub-housing remains in contact with one sidewall of the main housing 10 (an upper left sidewall in FIG. 1). These microphones MIC are spaced apart from each other at predetermined intervals along the direction of the long side of the sub-housing 12. A microphone array 1162 that picks up sound in an area outside the side surface of the sub-housing 12 along which the microphones MIC are set is built from the four microphones MIC. Sound signals picked up by the microphones MIC of the microphone arrays 1161 and 1162 are delivered to a sound pickup control section 113 of the main housing 11 by way of the pivotal joint sections 13A and 13B.

As shown in FIG. 2, the sound output-pickup function apparatus 1 additionally has, as functional sections, a control section 110, a sound output control section 112, a sound pickup control section 113, an echo canceller 114, and the speakers SP in the main housing 10, along with the foregoing input-output I/F 111, the operation section 115, the microphone arrays 1160, 1161, and 1162, and the rotary encoders 1171 and 1172.

The control section 110 controls the entirety of the sound output-pickup function apparatus 1. The control section 110 performs control operation in accordance with a command input by each of the operation members of the operation section 115. For instance, upon acceptance of an operation input for launching or completing a sound output-pickup application, the control section 110 controls the PC 2, which is connected to the control section by a USB cable 300 by way of the input-output I/F 111, to perform control initiation or completion of the sound output-pickup application. Upon acceptance of an operation input of assignment, the control section 110 conducts control performance of assignment to the PC 2. Upon acceptance of volume control of output sound, the control section 110 commands the sound output control section 112 to control a volume level of output sound. Upon acceptance of an operation input of microphone mute, the control section 110 commands; for instance, the sound pickup control section 113, to stop output of a picked-up sound signal.

When a usage mode is determined, the control section 110 provides the sound pickup control section 113 with a sound pickup directivity command for creating sound pickup directivity appropriate for the usage mode. The control section 110 acquires sound output directivity information from a sound-output audio signal with sound output directivity information input by way of the input-output I/F 111 and provides the sound output directivity command to the sound output control section 112.

In accordance with detection signals from the rotary encoders 1171 and 1172, the control section 110 detects amounts of turn and outputs the detected amounts of turn to the PC 2.

The input-output I/F 111 has the foregoing configuration and is connected to an equipment I/F 211 of the PC 2 by way of the USB cable 300 in the present embodiment. The input-output I/F 111 receives an output-sound audio signal and transmits an output picked-up sound signal. Upon receipt of the sound output directivity information along with the sound-output audio signal, the input-output I/F 111 delivers the sound output directivity information to the control section 110, as well as delivering the sound-output audio signal to the sound output control section 112 by way of the echo canceller 114. When transmitting the output picked-up sound signal, the input-output I/F 111 acquires the sound pickup directivity information from the control section 110 and transmits the acquired information in association with the output picked-up sound signal. The input-output I/F 111 exchanges various control signals between the control section 110 and the PC 2.

In accordance with the sound-output audio signal acquired by way of the PC 2 and the input-output I/F 111 and the sound output directivity command from the control section 110, the sound output control section 112 generates individual sound output drive signals to be delivered to the respective two speakers SP. Specifically, in accordance with the provided sound output directivity command, the sound output control section 112 determines a delay between the individual sound output drive signals imparted to the two speakers SP. The sound output control section 112 subjects the divided two sound-output audio signals to delay processing commensurate with the delay and outputs resultant signals as individual sound output drive signals to the two speakers SP. In accordance with the sound output control command of volume adjustment, the sound output control section 112 controls signal levels of the individual sound output drive signals.

The two speakers SP are spaced at a preset interval, such as that mentioned previously, and output sound in accordance with the individual sound output drive signals. The interval between the two speakers SP and the individual sound output drive signal output to the respective speakers are previously set in such a way that the speakers act as dipole speakers. A plurality of types of sound output directivity are implemented under these conditions.

The four microphones MIC of the microphone array 1160 provided on the main housing 10 take a predetermined area outside the front sidewall of the main housing 10 as a sound pickup area and pick up a speech in the sound pickup area, thereby generating a picked-up signal.

The four microphones MIC of the microphone array 1161 provided on the sub-housing 11 take a predetermined area outside the side surface of the sub-housing 11 along which the microphone array 1161 is arranged as a sound pickup area and pick up a speech in the sound pickup area, thereby generating a picked-up signal.

Likewise, the four microphones MIC of the microphone array 1162 provided on the sub-housing 12 take a predetermined area outside the side surface of the sub-housing 12 along which the microphone array 1162 is arranged as a sound pickup area and pick up a speech in the sound pickup area, thereby generating a picked-up signal.

The sound pickup control section 113 subjects sound signals picked up by the microphones MIC of the respective microphone arrays 1160, 1161, and 1162 to delay processing and addition processing in accordance with the sound pickup directivity command imparted from the control section 110, thereby generating an output picked-up sound signal picked up in compliance with the sound pickup directivity command and outputting the signal to the echo canceller 114. When a sound pickup direction can be acquired, the sound pickup control section 113 provides the control section 110 with sound pickup directivity information. When a plurality of persons are simultaneously speaking, an output picked-up sound signal and sound pickup directivity information are generated for each of the persons.

The echo canceller 114 has an adaptive filter and a post-processor including an adder. The adaptive filter generates a pseudo recurrent sound signal originating from an output sound signal and provides the pseudo recurrent sound signal to the adder of the post-processor. The adder of the post-processor subtracts the pseudo recurrent sound signal from the output picked-up sound signal, thereby cancelling an echo, and outputs a resultant signal to the input-output I/F 111. The post-processor feeds back an output result to the adaptive filter.

The PC 2 is; for instance, a general purpose personal computer and has a CPU 210, the equipment I/F 211, a communication I/F 212, a storage medium 213, RAM 214, an operation section 215, and a display section 216.

The CPU 210 utilizes the RAM 214 as a temporary memory area and a work area and performs various general purpose processing operations, including network communication and the like, in accordance with an input from the operation section 215. Upon acceptance of a sound output-pickup application launch control request from the sound output-pickup function apparatus 1, the CPU 210 reads and executes the sound output-pickup application program stored in the storage medium 213. The sound output-pickup application includes an indicator application and a positional relationship detection application. The CPU 210 calculates a positional relationship between the main housing 10 and the sub-housings 11 and 12 based on the acquired amount of turn, the positional relationship data and the usage mode data stored in the storage medium 213, thereby selecting the usage mode. The CPU 210 outputs an image produced by the sound output-pickup application, such as an image showing a selected usage mode and an image generated by general purpose processing, to the display section 216. Specifics to be executed by the sound output-pickup application are described later.

The equipment I/F 211 is a USB terminal and connected to the input-output I/F 111 of the sound output-pickup function apparatus 1 by way of the USB cable 300, thereby controlling communication between the CPU 210 and the sound output-pickup function apparatus 1.

The communication I/F 212 is; for instance, a LAN terminal and connected to a network 400 by way of the network cable.

The storage medium 213 is made up of; for instance, a hard disk drive (HDD), and stores a general purpose processing program for a PC and the sound output-pickup application, the usage mode data, the positional relationship data, and the like. The usage mode data are data including the number of persons, positions of persons, a positional relationship between the main housing and the sub-housings, and an adaptive sound pickup range. A reference is made to the usage mode data during execution of the sound output-pickup application. The positional relationship DB is a relational database for bringing an amount of turn into relationship with a position

The operation section 215 is; for instance, a keyboard and a mouse; accepts an operation input from the users; and delivers the accepted input to the CPU 210.

The display section 216 is made up of; for instance, a liquid-crystal display panel, and displays an application image, or the like, received from the CPU 210.

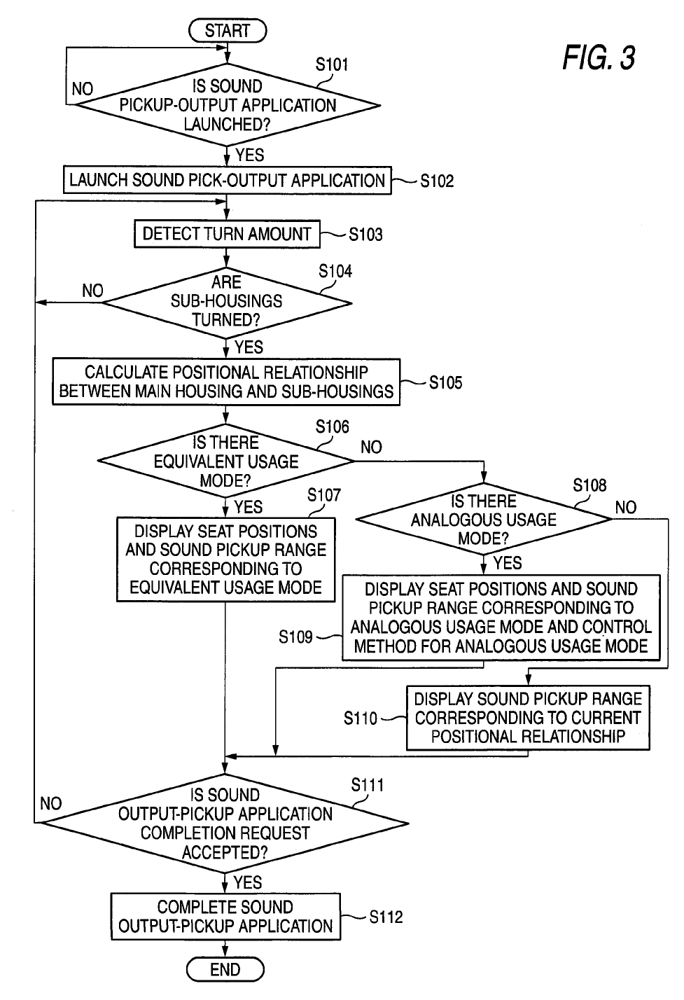

A flow of execution of the sound output-pickup application, which is the characteristic of the embodiment, is now described by reference to a flowchart shown in FIG. 3. An operation member accepting operation pertaining to the sound output-pickup application is hereinbelow referred to as a “sound output-pickup application operation member.” A description is now given to a case where initiation and completion of the sound output-pickup application can be performed by the sound output-pickup application operation member.

FIG. 3 is a flowchart showing a flow of execution of the sound output-pickup application.

First, the sound output-pickup function apparatus 1 and the PC 2 are already initiated, and the PC 2 establishes network communication by user operation while the sound output-pickup function apparatus 1 and the PC 2 are connected together by the USB cable 300. When any of the users operates the sound output-pickup application operation member of the sound output-pickup function apparatus 1 in this state, the sound output-pickup function apparatus 1 accepts operation (Y in S101) and transmits a sound output-pickup application start command to the PC 2. The sound output-pickup function apparatus 1 does not transmit the sound output-pickup application initiation command to the PC 2 before receiving a start input entered by the sound output-pickup application operation member (N in S101). Specifically, the sound output-pickup function apparatus 1 serves merely as an apparatus that only outputs and picks up sound by performing voice communication with another sound pickup apparatus that is connected to the PC 2 by way of the network 400 and that is located at another point, so long as the sound output-pickup application start command is not received.

Upon acceptance of the sound output-pickup application start command, the CPU 210 of the PC 2 reads and executes the sound output-pickup application stored in the storage medium 213 (S102). The sound output-pickup application includes an indicator application and a positional relationship detection application. The CPU 210 executes the positional relationship detection application, thereby transmitting a turn amount detection command to the sound output-pickup function apparatus 1. In accordance with the turn amount detection command, the sound output-pickup function apparatus 1 starts to detect a turn amount and transmits the detected turn amount to the PC 2 (S103). Every time a detection signal is received from each of the rotary encoders 1171 and 1172 since detection of a turn amount was started, the sound output-pickup function apparatus 1 transmits a turn amount to the PC 2.

When acquired the turn amount; namely, when detected turning of the sub-housing 11 or the sub-housing 12 with reference to the main housing 10 (Y in S104), the CPU 210 reads positional relationship data and calculates a positional relationship between the main housing 10 and the sub-housing 11 or 12 (S105). The calculated positional relationship is stored in the storage medium 213 in an updating manner. Meanwhile, when a turn amount is not detected, processing subsequent to S105 is not performed until a turn amount is newly acquired (when N is selected in S104, processing returns to S103).

The CPU 210 reads the usage mode data stored in the storage medium 213 and detects whether there is a usage mode including a positional relationship equivalent to the calculated positional relationship. A determination as to whether or not a positional relationship is equivalent to a calculated positional relationship is made on the basis of a result of a determination; for instance, as to whether or not a calculated positional relationship, i.e., an angle between the main housing 10 and each of the sub-housings 11 and 12, falls within an angle range of ±10 degrees with respect to an angle between the main housing 10 and each of the sub-housings 11 and 12 corresponding to each of the usage modes stored as the usage mode data.

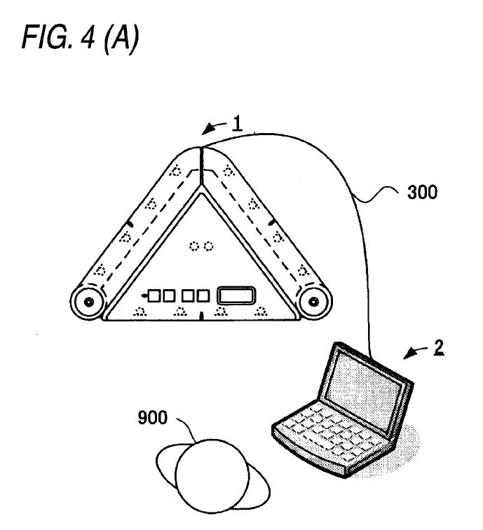

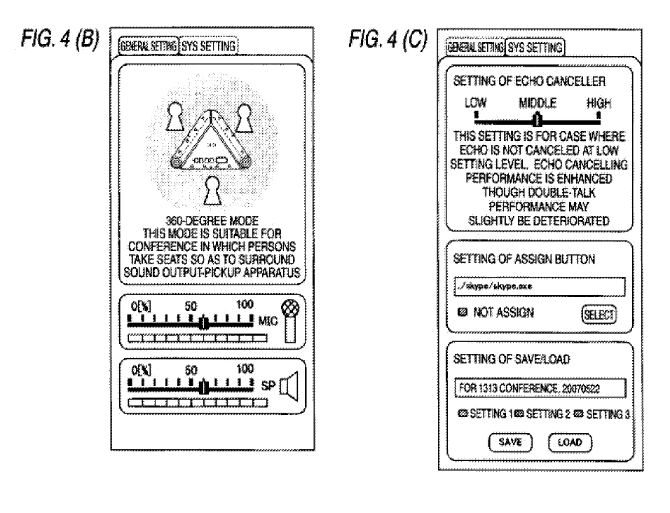

When detected the usage mode including an equivalent positional relationship (Y in S106), the CPU 210 reads the number of persons, positions of persons, and an adaptive sound pickup range corresponding to the usage mode. The CPU then generates indicator display data, such as those shown in; for instance, FIG. 4(B), and causes the display section 216 to display the data (S107). Users can ascertain the number of persons, seat positions for persons, and a sound pickup range that are optimum for the current sound output-pickup function apparatus 1 by taking a view of the indicator display, and can take seats in accordance with the indicator display. A conference can be held in an optimum sound pickup environment, so long as the persons take seats in accordance with the indicator display.

When a usage mode including an equivalent positional relationship cannot be detected (N in S106), the CPU 210 detects an analogous usage mode. For instance, a determination is made by determining if the calculated positional relationship; namely, an angle between the main housing 10 and each of the sub-housings 11 and 12, falls within an angle range of ±30 degrees with respect to the angle between the main housing 10 and each of the sub-housings 11 and 12 corresponding to each of the usage modes stored as the usage mode data.

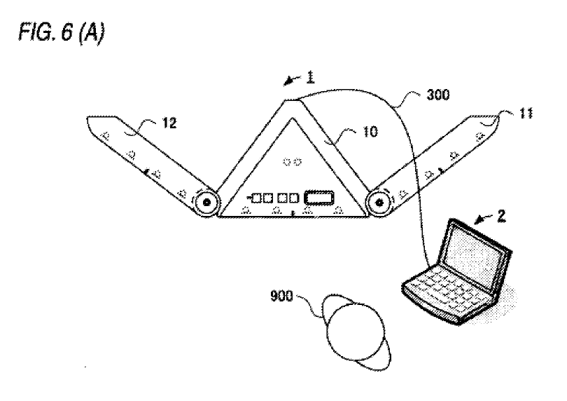

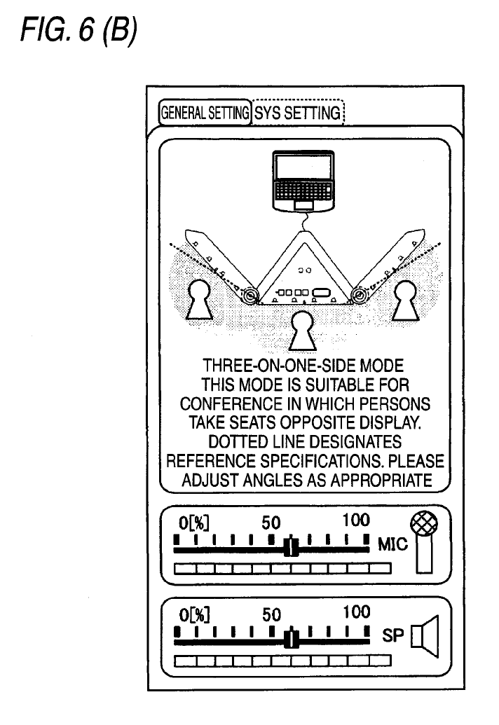

Upon detection of a usage mode including an analogous positional relationship (Y in S108), the CPU 210 reads the number of persons, person's positions, and an adaptive sound pickup range corresponding to the detected usage mode. The CPU also generates indicator display data including the analogous positional relationship and the calculated positional relationship, such as that shown in; for instance, FIG. 6(B), and causes the display section 216 to display the data (S109). By glancing the indicator display, the users can ascertain that there is no usage mode optimum for the current state of the sound output-pickup function apparatus 1 and that an analogous usage mode is available. The sub-housings 11 and 12 can further be turned so as to achieve an analogous usage mode. If the CPU 210 simultaneously, additionally displays, at this time, a turn amount and a direction of turn for causing the detected current positional state to match the analogous positional relationship, the users can turn the sub-housings 11 and 12 in an easier fashion until the analogous usage mode is achieved. The turns achieved at this time are reflected on the indicator display. Namely, the display of the positional relationship is gradually changed in synchronism with the turning action, whereby operation for achieving the analogous usage mode can be submitted to the users in a more easily understandable manner. A conference can be made in an optimum sound pickup environment, so long as the users take seats in accordance with the indicator display after performance of additional turning action.

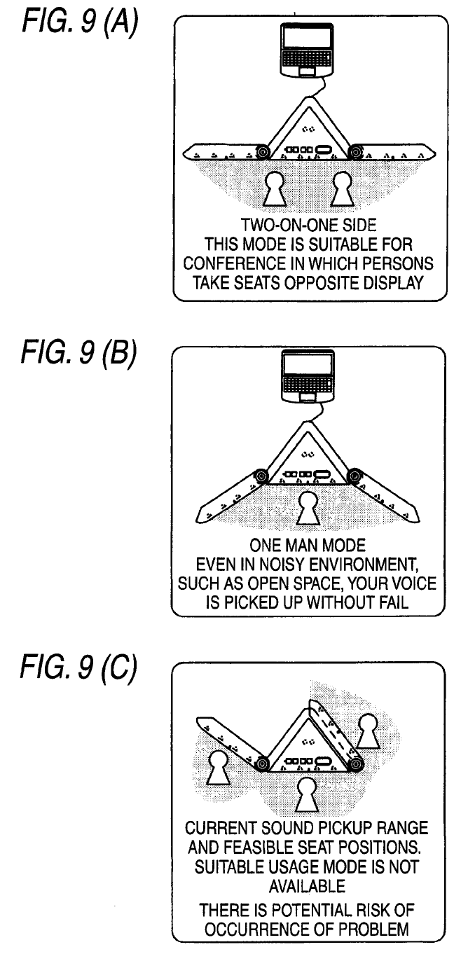

When neither a usage mode including an equivalent positional relationship nor a usage mode including an analogous positional relationship can be detected (N in S108), the CPU 210 displays, on the indicator display, absence of a usage mode suitable for a current positional relationship and a sound pickup range for a case where sound is picked up at the current positional relationship as shown in; for instance, FIG. 9C (S110). The users can ascertain absence of an appropriate usage mode and a potential problem in sound output or pickup in the current state of the sound output-pickup function apparatus 1 by taking a look at the indicator display. The users further turn the sub-housings 11 and 12, as required, while taking a view of the indicator display.

The foregoing processing operations are continually carried out until the sound output-pickup function apparatus 1 accepts sound output-pickup application completion operation performed by the sound output-pickup application operation member (N in S111). Therefore, if the users turn the sub-housings 11 and 12 in the middle of the sound output-pickup application being executed, the usage mode will again be evaluated by the turning actions, whereby an indicator display commensurate with results of a reevaluation is provided.

Meanwhile, when the sound output-pickup function apparatus 1 accepts the sound output-pickup application completion operation performed by the sound output-pickup application operation member (Y in S111), the CPU 210 will perform processing for completing the sound output-pickup application, whereupon the indicator display disappears (S112).

The foregoing descriptions have provided the example in which a determination is sequentially made as to an equivalent usage mode and an analogous usage mode. Alternatively, a determination may also be made as to whether or not an equivalent usage mode is available, without making a determination as to an analogous usage mode, and a determination result may also be provided as an indicator display. A determination as to whether or not an optimum usage mode is available can be submitted to the users more briefly and quickly.

A state of the sound output-pickup function apparatus achieved during setting and a state of the sound output-pickup function apparatus achieved during actual usage (i.e., during a conference) are now described in more detail by reference to the drawings.

### First Embodiment

### When an Equivalent Usage Mode is Available

The first embodiment shows, as an example, a case where the sub-housings 11 and 12 are brought into contact with sides of the triangle.

FIG. 4(A) is a view of the embodiment; namely, a setting state in which the sub-housings 11 and 12 are arranged in alignment with the main housing 10. FIG. 4(B) is a view showing an indicator display screen of the PC 2 acquired in the setting state shown in FIG. 4(A). FIG. 4(C) is a view showing a system setting display screen.

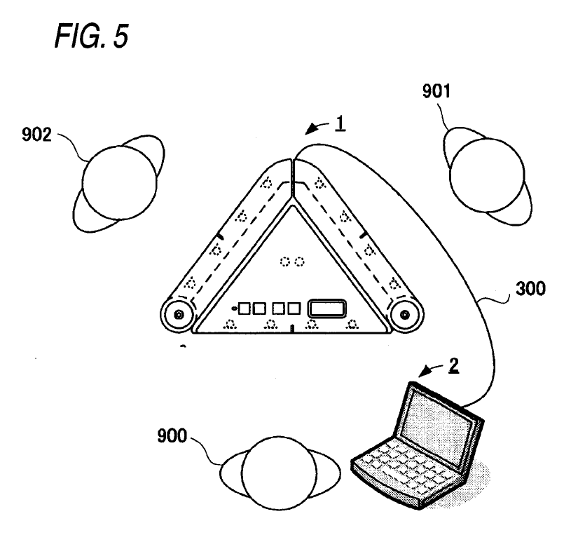

FIG. 5 is a view showing a state in which users actually take seats after performance of the settings shown in FIGS. 4(A), (B), and (C).

A user 900 places the sound output-pickup function apparatus 1 at a predetermined position; for instance, on a conference table in a conference room. On that occasion, a user 900 appropriately positions the sub-housings 11 and 12 with respect to the main housing 10. For instance, as shown in FIG. 4(A), the sub-housings 11 and 12 are arranged in alignment with the main housing 10. The user 900 connects the sound output-pickup function apparatus 1 to; for instance, the PC 2 set at hand, by the USB cable 300, and starts the sound output-pickup function apparatus 1 and the PC 2. Further, the user 900 actuates the sound output-pickup application operation member with respect to the sound output-pickup function apparatus 1, thereby launching and executing the sound output-pickup application. When the sound output-pickup application is executed, turn amounts are detected, whereby a positional relationship between the main housing 10 and the sub-housings 11 and 12 is detected. When the positional relationship is detected, an equivalent usage mode is selected. A plurality of types of usage modes are set in advance. In the present first embodiment, a “360-degree mode” in which conferees take seats along respective sides of a triangle of the main housing 10 is determined to be equivalent. Thus, when a usage mode determined to be equivalent is available, the shape of the sound output-pickup function apparatus 1 (i.e., a positional relationship between the main housing 10 and the sub-housings 11 and 12), a sound pickup range (an area filled in with a pale color in the drawing), a recommended optimum number of persons, and recommended optimum positions for the persons, all conforming to the equivalent usage mode, graphically appear in the indicator display as shown in FIG. 4(B). As shown in FIG. 4(B), a brief description of the mode can also be displayed at this time.

So long as the indicator display is provided as mentioned above, an optimum use method appropriate for the shape of the current sound output-pickup function apparatus 1 can be submitted to the user 900 who performs setting.

When considered that the number of persons, the person's positions, and the sound pickup range of the recommended mode produce no problem, by taking a look at the indicator display, the user 900 starts a conference by taking a seat at a recommended position for a person along with other users 901 and 902, as shown in FIG. 5. Sound of the respective users 900 to 902 can be reliably picked up and output without fail.

As shown in FIG. 4(C), a system setting screen can also be provided in the form of a window differing from the indicator display. The system setting screens displays settings of the foregoing assignment, settings of an echo canceller, a memory location where the settings are to be stored, and a location where previously set data are to be loaded, thereby enabling performance of operations pertaining to setting in the form of GUI control. The user 900 can readily perform installation setting and system setting in a unified fashion, so long as such a system setting window is provided simultaneously with the indicator display.

### Second Embodiment

### A Case where an Equivalent Usage Mode is not Available and where an Analogous Usage Mode is Present

The second embodiment provides an example in which the sub-housings 11 and 12 are turned to such an extent as not to become parallel to the front sidewall of the main housing 10.

FIG. 6(A) is a view showing a setting state of the present embodiment; namely, a state in which the sub-housings 11 and 12 are not arranged in alignment with the main housing 10, and FIG. 6(B) is a view showing an indicator display screen of the PC 2 achieved in the setting state shown in FIG. 6(A).

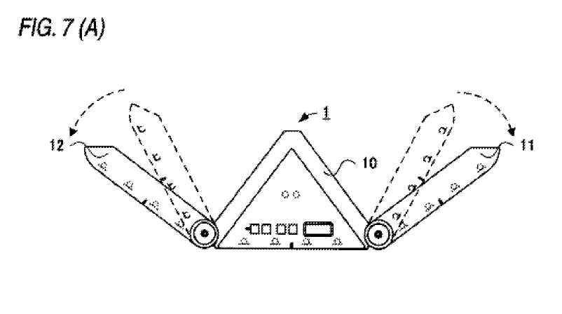

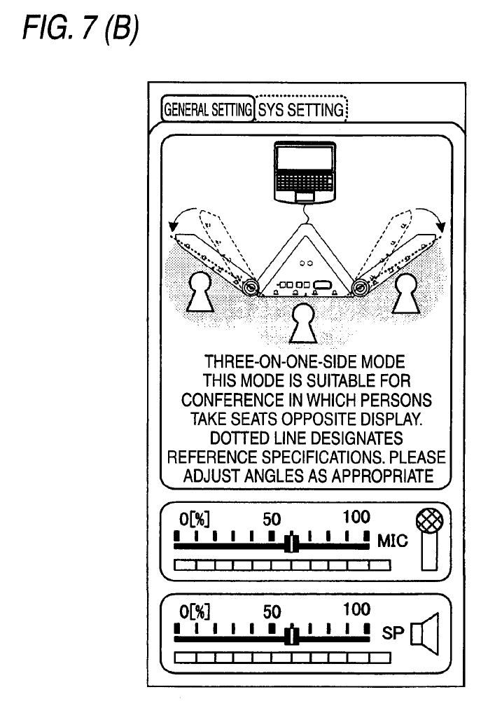

FIG. 7(A) is a view showing operation for turning the sub-housings, and FIG. 7(B) is a view showing a change in indicator display occurred when turning operation is further performed from the positions shown in FIG. 7(A).

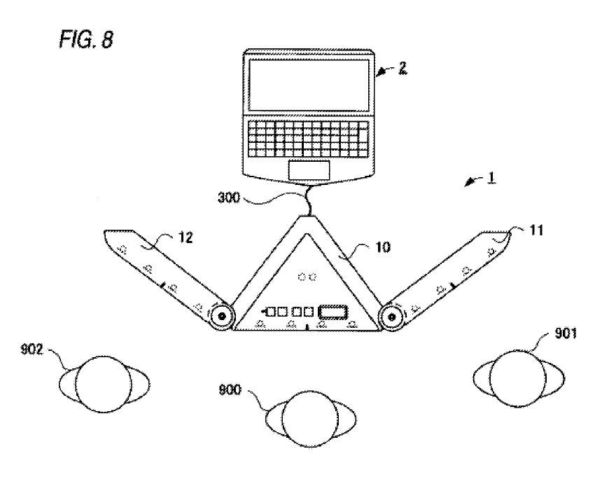

FIG. 8 is a view showing a state in which the users actually take seats after performance of the settings shown in FIGS. 6(A) and (B).

As in the case of the first embodiment, the user 900 places the sound output-pickup function apparatus 1, connects the apparatus to the PC 2, and launches the sound output-pickup application. On this occasion, as shown in FIG. 6(A), the sub-housings 11 and 12 are turned through predetermined turn amounts with respect to the main housing 10 in the present embodiment. When the sound output-pickup application is executed, turn amounts are detected, whereby a positional relationship between the main housing 10 and the sub-housings 11 and 12 is detected. When the positional relationship is detected, it is determined whether or not an equivalent usage mode is available. When an equivalent usage mode is not available, it is further determined whether or not an analogous usage pattern is available. In the case of the second embodiment, a “three-on-one-side mode” in which three conferees take seats along the front sidewall of the main housing 10 is determined to be analogous.

When an analogous usage mode is determined to be present, optimum turning positions of the sub-housings 11 and 12 based on the analogous usage mode (indicated by dotted lines in the drawing), a sound pickup range, a recommended optimum number of persons, and optimum positions for persons, and the shape of the sound output-pickup function apparatus 1 based on the detected current positional relationship are graphically displayed in the indicator display as shown in FIG. 6(B). It is better, on this occasion, to additionally display a turning method to achieve an analogous usage mode and an additional cautions along with a brief description of the mode.

The optimum usage mode close to the current shape of the sound output-pickup function apparatus 1 and an adjustment method to achieve the optimum usage mode can be provided to the user 900 who performs setting, by provision of the indicator display as mentioned above.

While taking a look at the indicator display, the user 900 further turns the sub-housings 11 and 12 as shown in FIG. 7(A), so as to achieve the recommended, analogous usage mode. When such additional turning operation is performed, the sub-housings are also displayed on the indicator display as being turned in synchronism with turning actions of the sub-housings 11 and 12 as shown in FIG. 7(B). The user can thereby readily ascertain an extent to which the sub-housings have become close to the analogous usage mode or whether or not the sub-housings have matched the analogous usage mode. After performance of such turning operation, the user takes a seat at the recommended position for a person along with the other users 901 and 902 as shown in FIG. 8, whereby a conference is commenced. Sound of the respective users 900 to 902 can thereby be picked up or output without fail. So long as the PC 2 or another display prepared for the conference is placed at a recommended position, the respective users 900 to 902 can take a look at a video when a TV conference is performed. A change in sound pickup range or a change in person's positions can also be displayed simultaneously with changes in the display of the sub-housings synchronized with turning actions.

The foregoing two embodiments correspond to some of example usage modes that can be embodied by the present sound output-pickup function apparatus, and other usage modes are also feasible. Indicator displays may vary according to the respective usage modes. Further, even when an optimum usage mode is not available for the current shape of the sound output-pickup function apparatus, an indicator display is provided. FIGS. 9(A), (B), and (C) also show some of additional examples.

FIGS. 9(A) and 9(B) show indicator displays of another usage mode, and FIG. 9(C) shows an indicator display acquired when an appropriate usage mode is not available.

FIG. 9(A) shows a case of “two-on-one-side mode.” In the case of the two-on-one-side mode, there is adopted a shape in which the front sidewall of the main housing 10 becomes parallel to the long sides of the respective sub-housings 11 and 12. So long as a positional relationship between the main housing 10 and the sub-housings 11 and 12, which is analogous to the shape, is detected, an indicator display shown in FIG. 9(A) is provided.

FIG. 9B shows a case of “one man” mode. A layout applied to the one man mode is that the sub-housings 11 and 12 are turned further outward with reference to the front sidewall of the main housing 10. When a positional relationship between the main housing 10 and the sub-housings 11 and 12 equivalent to such a layout is detected, an indicator display shown in FIG. 9(B) is provided.

FIG. 9(C) shows a case where an appropriate usage mode is not available. When an appropriate usage mode is not available, the current positional relationship between the main housing 10 and the sub-housings 11 and 12 is displayed, and an estimated sound pickup range that is feasible at the positional relationship is displayed. Person's positions that are feasible within the estimated sound pickup range and cautions pertaining to the person's positions are also displayed. Indicating such a display makes it possible to provide the user with a potential risk of occurrence of a failure to pickup users' remarks if a conference is conducted in this mode as well as with the fact that the current positional relationship does not belong to any appropriate usage modes.

Although the foregoing embodiment shows a case where provision of an indicator display and selection or determination of a usage mode are carried out by use of a general purpose PC, a remote controller specifically designed for the sound output-pickup function apparatus 1 can also be used. In this case, the remote controller is provided solely with an indicator display function and an operation input function appurtenant to the display function. The sound output-pickup function apparatus 1 is caused to perform processing pertaining to execution of the sound output-pickup application including selection of the usage mode, and the like, processing pertaining to a storage medium, and a communication function. A sound pickup apparatus including the sound output-pickup function apparatus 1 and the PC 2 can thereby be substantially implemented by only the sound output-pickup function apparatus 1.

Although the turn amount is detected by use of the rotary encoder in the embodiment, the turn amount can also be detected by outputting test sound from the speakers SP and picking up the test sound by the microphones MIC. In this case, the sound output-pickup function apparatus 1 subjects sound pickup signals output from the microphones MIC of the respective microphone arrays 1160, 1161, and 1162 to delay control including different patterns, thereby generating a plurality of sound pickup beam signals. The sound output-pickup function apparatus 1 stores a distribution of levels of a plurality of sound pickup beam signals for each of turn amounts of the sub-housings 11 and 12; namely, each of the positional relationships between the main housing 10 and the sub-housings 11 and 12. The sound output-pickup function apparatus 1 calculates a distribution of level for the acquired plural sound pickup beam signals and compares a resultant level distribution with the stored level distribution, thereby detecting a turn amount. A turn amount is thus detected by such a sound output-pickup function, as a result of which it becomes possible to detect a turn amount without attachment of a component that is not relevant directly to a sound output pickup function, such as a rotary encoder. A component configuration of the sound output-pickup function apparatus 1 can be simplified.

Although the foregoing description has provided an example in which the sub-housings 11 and 12 are manually turned, the sub-housings 11 and 12 can also be automatically turned by combination of a motor, gears, and the like. In this case, the user can much simply perform turning operation while viewing an indicator display, so long as the PC 2 or the remote controller is provided with an operation input section for performing turning operation. Further, when an analogous usage mode is available, the sound output-pickup function apparatus 1 can automatically be turned.

The present embodiment has described the sound pickup apparatus by taking, by way of example, the sound output-pickup function apparatus 1. The sound output-pickup function apparatus 1, however, does not need to have the microphones MIC (a sound output function).

Although the present invention has been described in detail and by reference to the specific embodiment, it is manifest to those skilled in the art that the present invention be susceptible to various alterations or modifications without departing the sprit, scope, and purpose of the present invention.

The present patent application is based on Japanese Patent Application (JP-A-2007-228683) filed on Sep. 4, 2007 in Japan, the entire subject matter of which is incorporated herein by reference.

1. A sound pickup apparatus, comprising:
a main housing having a sound pickup section;
a plurality of sub-housings, each of which has a sound pickup section and is provided so as to be turnable with respect to the main housing;
a turn amount detection section that detects amounts of turns of the plurality of sub-housings with respect to the main housing;
a usage mode determination section that detects an actually measured positional relationship between the main housing and the plurality of sub-housings based on the amounts of the turns and determines an optimum usage mode appropriate for the actually measured positional relationship;
a display control section that generates display data including the actually measured positional relationship and the optimum usage mode; and
a display section that displays the display data.

2. The sound pickup apparatus according to claim 1, wherein the usage mode determination section:
stores a plurality of usage modes and preset positional relationships between the main housing and the plurality of sub-housings corresponding to the plurality of usage modes while associating the plurality of usage modes with the positional relationships respectively,
determines a usage mode corresponding to the actually measured positional relationship as the optimum usage mode when the actually measured positional relationship is equal to any one of the preset positional relationships corresponding to the stored usage modes, and
determines that an appropriate usage mode is not available when the actually measured positional relationship is not equal to any one of the preset positional relationships corresponding to the stored usage modes; and
wherein the display control section generates the display data including absence of the appropriate usage mode and the actually measured positional relationship when the appropriate usage mode is not available.

3. The sound pickup apparatus according to claim 2, wherein the usage mode determination section determines a usage mode of an analogous preset positional relationship as the optimum usage mode when the actually measured positional relationship is analogous to any one of the preset positional relationships corresponding to the stored usage modes; and
wherein the display control section generates the display data including the analogous preset positional relationship and the actually measured positional relationship when the usage mode corresponding to the analogous preset positional relationship is available.

4. The sound pickup apparatus according to claim 1, wherein the turn amount detection section detects a change in the amounts of the turns;
wherein the usage mode determination section detects a change in the actually measured positional relationship corresponding to the change in the amounts of the turns; and
wherein the display control section generates the display data in accordance with the change in the actually measured positional relationship.

5. The sound pickup apparatus according to claim 1, wherein the turn amount detection section is a rotary encoder.

6. The sound pickup apparatus according to claim 1, wherein the main housing further includes a sound output section; and
wherein the turn amount detection section detects the amounts of the turns based on a relationship of delay in picked-up audio signals acquired by picking up a sound output from the sound output section at the sound pickup sections of the main housing and the plurality of sub-housings.

7. The sound pickup apparatus according to claim 1, further comprising:
a turning section that turns the plurality of sub-housings with respect to the main housing; and
a turning operation input section that accepts an operation input regarding the turn of the turning section,
wherein the main housing, the sub-housings, the turn amount detection section, and the turning section are provided in a main device that is stationarily set at a predetermined position; and
wherein the display section and the turning operation input section are provided in an operation device that is separated from the main device, that is movable, and that is capable of establishing a communication with the main device.
